(19) United States
(12) Patent Application Publication
(10) Pub. No.: US 2024/0144590 A1
(43) Pub. Date: May 2, 2024

(54) VIRTUAL OBJECT PLACEMENT BASED ON REFERENTIAL EXPRESSIONS

(71) Applicant: APPLE INC., Cupertino, CA (US)

(72) Inventors: Alkeshkumar M. PATEL, San Jose, CA (US); Saurabh ADYA, San Jose, CA (US); Shruti BHARGAVA, Santa Clara, CA (US); Angela BLECHSCHMIDT, San Jose, CA (US); Vikas R. NAIR, San Francisco, CA (US); Alexander S. POLICHRONIADIS, San Francisco, CA (US); Kendal SANDRIDGE, San Francisco, CA (US); Daniel ULBRICHT, Sunnyvale, CA (US); Hong YU, Santa Clara, CA (US)

(21) Appl. No.: 18/279,752

(22) PCT Filed: Feb. 25, 2022
(86) PCT No.: PCT/US22/17967

§ 371 Date: Aug. 31, 2023

Related U.S. Application Data
(60) Provisional application No. 63/155,070, filed on Mar. 1, 2021.

(51) Int. Cl. G06T 17/00; G06V 10/25; G10L 15/22

(52) U.S. Cl. CPC G06T 17/00; G06V 10/25; G10L 15/22; G06V 2201/07; G10L 2015/223

(57) ABSTRACT

In an exemplary process, a speech input including a referenced virtual object is received. Based on the speech input, a first reference set is obtained. The first reference set is then compared to a plurality of second reference sets. Based on the comparison, a second reference set from the plurality of second reference sets is obtained. The second reference set may be identified based on a matching score between the first reference set and the second reference set. An object is then identified based on the second reference set. Based on the identified object, the reference virtual object is displayed.

### CROSS REFERENCE TO RELATED APPLICATIONS

This application claims priority to U.S. Provisional Application No. 63/155,070, entitled “VIRTUAL OBJECT PLACEMENT BASED ON REFERENTIAL EXPRESSIONS,” filed Mar. 1, 2021, the content of which is hereby incorporated by reference in its entirety for all purposes.

### BACKGROUND

### Field

The present disclosure relates generally to extended reality, and more specifically to techniques for virtual object placement based on referential expressions.

### Description of Related Art

Traditional extended reality environments may include various representations of virtual and physical objects. A user viewing the environment may interact with the objects using various methodologies.

### BRIEF SUMMARY

This disclosure describes techniques for virtual object placement in an extended reality setting. Extended reality environments provide a platform to enable users to interact with various objects in the environment. For example, a user may place a virtual object at a specific location within the environment, using methods including physical controls, speech commands, gaze-based operations, and the like. When using speech commands, the user may refer to various objects depicted in the environment as referential objects, such as furniture, walls, appliances, or other objects. These objects may serve as reference points within the environment in order to target the location the user wishes to place a respective virtual object. Accordingly, a method and system for virtual object placement based on referential expressions is desired.

According to some embodiments, a speech input including a referenced virtual object is received. Based on the speech input, a first reference set is obtained. The first reference set is then compared to a plurality of second reference sets. Based on the comparison, a second reference set from the plurality of second reference sets is obtained. The second reference set may be identified based on a matching score between the first reference set and the second reference set. An object is then identified based on the second reference set. Based on the identified object, the referenced virtual object is displayed.

### BRIEF DESCRIPTION OF FIGURES

FIGS. 1A-1B depict exemplary systems for use in various extended reality technologies.

FIGS. 2A-2B depict an exemplary process for obtaining a plurality of reference sets based on image information.

FIG. 3 depicts an exemplary process for virtual object placement using a referential expression.

FIGS. 4A-4B depict an exemplary process for virtual object placement using a referential expression.

FIG. 5 depicts an exemplary process for virtual object placement using a referential expression.

### DESCRIPTION

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

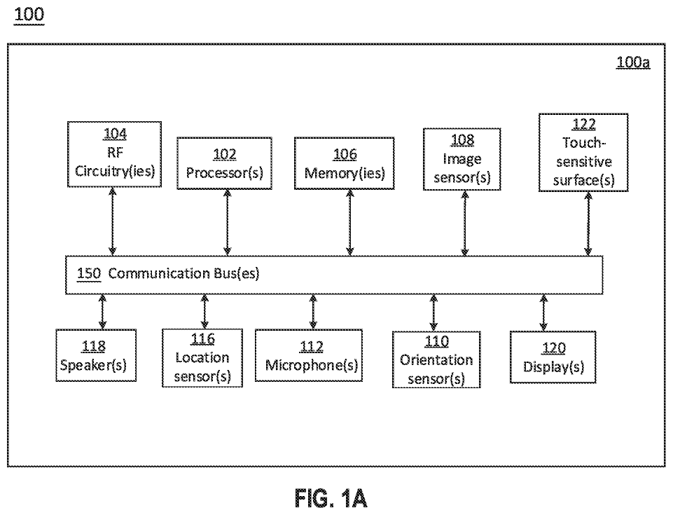

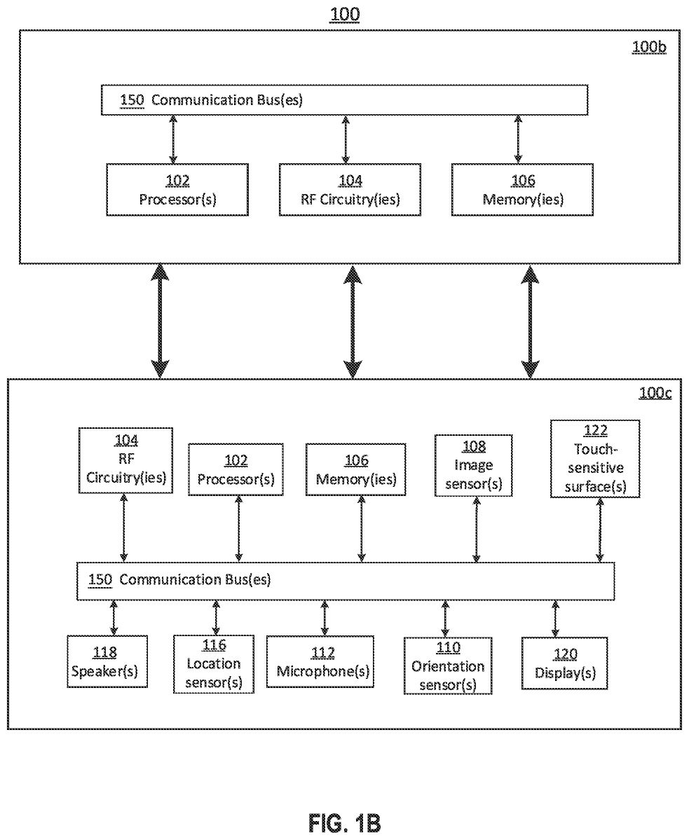

FIG. 1A and FIG. 1B depict exemplary system 100 for use in various extended reality technologies.

As shown in FIG. 1A, system 100 includes device 100a. Device 100a includes RF circuitry(ies) 104, processor(s) 102, memory(ies) 106, image sensor(s) 108, touch-sensitive surface(s) 122, speaker(s) 118, location sensor(s) 116, microphone(s) 112, orientation sensor(s) 110, and display(s) 120. These components optionally communicate using communication bus(es) 150 of device 100a.

In some examples, a base station device (e.g., a computing device, such as a remote server, mobile device, or laptop) implements some components of system 100 and a second device (e.g., a head-mounted device) implements other components of system 100. In some examples, device 100a is implemented in a base station device or in a second device.

As shown in FIG. 1B, in some examples, system 100 includes two or more devices in communication, e.g., via a wired connection or a wireless connection. First device 100b (e.g., a base station device) includes memory(ies) 106, RF circuitry(ies) 104, and processor(s) 102. Such components optionally communicate using communication bus(es) 150 of device 100b. Second device 100c (e.g., a head-mounted device) includes components such as RF circuitry(ies) 104, processor(s) 102, memory(ies) 106, image sensor(s) 108, touch-sensitive surface(s) 122, speaker(s) 118, location sensor(s) 116, microphone(s) 112, orientation sensor(s) 110, and display(s) 120. These components optionally communicate using communication bus(es) 150 of device 100c.

System 100 includes RF circuitry(ies) 104. RF circuitry(ies) 104 optionally include circuitry for communicating with networks (e.g., the Internet, a wireless network (e.g., such as cellular networks and wireless local area networks (LANs)), and/or intranets) and/or electronic devices. RF circuitry(ies) 104 optionally includes circuitry for communicating using near-field communication and/or short-range communication (e.g., Bluetooth®).

System 100 includes processor(s) 102 and memory(ies) 106. Processor(s) 102 include one or more graphics processors, one or more general processors, and/or one or more digital signal processors. In some examples, memory(ies) 106 are one or more non-transitory computer-readable storage mediums (e.g., random access memory, flash memory) storing computer-readable instructions configured to be executed by processor(s) 102 to perform the techniques described below

System 100 includes image sensor(s) 108. Image sensors(s) 108 optionally include one or more infrared (IR) sensor(s), e.g., a passive IR sensor or an active IR sensor, to detect infrared light from the physical environment. For example, an active IR sensor includes an IR emitter (e.g., an IR dot emitter) for emitting infrared light into the physical environment. Image sensor(s) 108 also optionally include one or more visible light image sensors, such as complementary metal-oxide-semiconductor (CMOS) sensors and/or charged coupled device (CCD) sensors capable of obtaining images of physical elements from the physical environment. Image sensor(s) 108 also optionally include one or more event camera(s) configured to capture movement of physical elements in the physical environment. Image sensor(s) 108 also optionally include one or more depth sensor(s) capable of detecting the distance of physical elements from system 100. In some examples, system 100 uses IR sensors, CCD sensors, event cameras, and depth sensors together to detect the physical environment around system 100. In some examples, image sensor(s) 108 include first and second image sensors. The first and second image sensors are optionally capable of capturing images of physical elements in the physical environment from two respective different perspectives. In some examples, system 100 uses image sensor(s) 108 to detect the position and orientation of system 100 and/or display(s) 120 in the physical environment. For example, system 100 uses image sensor(s) 108 to track the position and orientation of display(s) 120 relative to one or more fixed elements in the physical environment. In some examples, image sensor(s) 108 are capable of receiving user inputs, such as hand gestures.

In some examples, system 100 includes touch-sensitive surface(s) 122 for receiving user inputs, such as tapping or swiping inputs. In some examples, touch-sensitive surface(s) 122 and display(s) 120 are combined into touch-sensitive display(s).

In some examples, system 100 includes microphones(s) 112. System 100 uses microphone(s) 112 to detect sound from the user's physical environment or from the user. In some examples, microphone(s) 112 includes a microphone array (e.g., including a plurality of microphones) that optionally operate together, e.g., to locate the spatial source of sound from the physical environment or to identify ambient noise.

System 100 includes orientation sensor(s) 110 for detecting orientation and/or movement of system 100 and/or display(s) 120. For example, system 100 uses orientation sensor(s) 110 to track changes in the position and/or orientation of system 100 and/or display(s) 120, such as relative to physical elements in the physical environment. Orientation sensor(s) 110 optionally include gyroscope(s) and/or accelerometer(s)

System 100 includes display(s) 120. Display(s) 120 may operate with a transparent or semi-transparent displays (and optionally with one or more imaging sensors). Display(s) 120 may include an opaque display. Display(s) 120 may allow a person to view a physical environment directly through the display, and may also allow addition of virtual content to the person's field of view, e.g., by superimposing virtual content over the physical environment. Display(s) 120 may implement display technologies such as a digital light projector, a laser scanning light source, LEDs, OLEDs, liquid crystal on silicon, or combinations thereof. Display(s) 120 can include substrates through which light is transmitted, e.g., optical reflectors and combiners, light waveguides, holographic substrates, or combinations thereof. As a particular example, the transparent or semi-transparent display may selectively transition between a transparent or semi-transparent state and an opaque state. Further example implementations of display(s) 120 include display-capable lenses, tablets, smartphones, desktop computers, laptop computers, heads up displays, display-capable automotive windshields, or display-capable windows. In some examples, system 100 is a projection-based system. For example, system 100 projects virtual objects onto a physical environment (e.g., projects a holograph onto a physical environment or projects imagery onto a physical surface). As another example, system 100 uses retinal projection to project images onto a person's eyes (e.g., retina). In some examples, system 100 can be configured to interface with an external display (e.g., a smartphone display).

System 100 may further include one or more speech-to-text (STT) processing modules each including one or more automatic speech recognition (ASR) systems for performing speech-to-text conversions on speech received from the various microphones. Each ASR system may include one or more speech recognition models and may implement one or more speech recognition engines. Examples of speech recognition models may include but are not limited to include Deep Neural Network Models, n-gram language models, Hidden Markov Models (HMM), Gaussian-Mixture Models, and the like. A natural language processing module may further obtain candidate text representations of the speech input and associate each of the candidate text representations with one or more recognizable “actionable intents.” In some examples, the natural language processing is based on use of ontologies. An ontology is a hierarchical structure containing many nodes, each node representing an actionable intent related to other actionable intents. These actionable intents may represent tasks that the system is capable of performing. The ontology may further include properties representing parameters associated with an actionable intent, a sub-aspect of another property, and the like. A linkage between an actionable intent node and a property node in the ontology may define how parameters represented by the property node are related to the task represented by the actionable intent node.

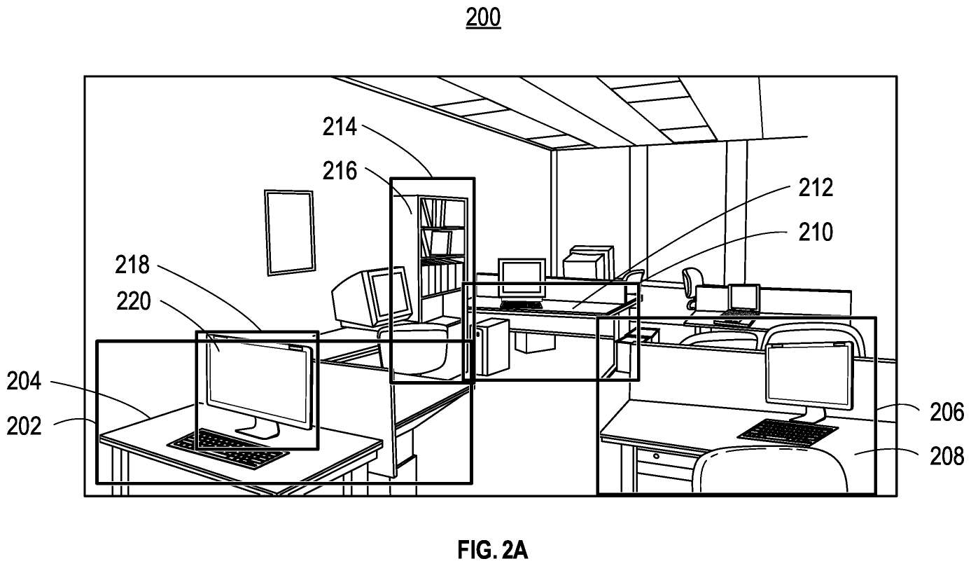

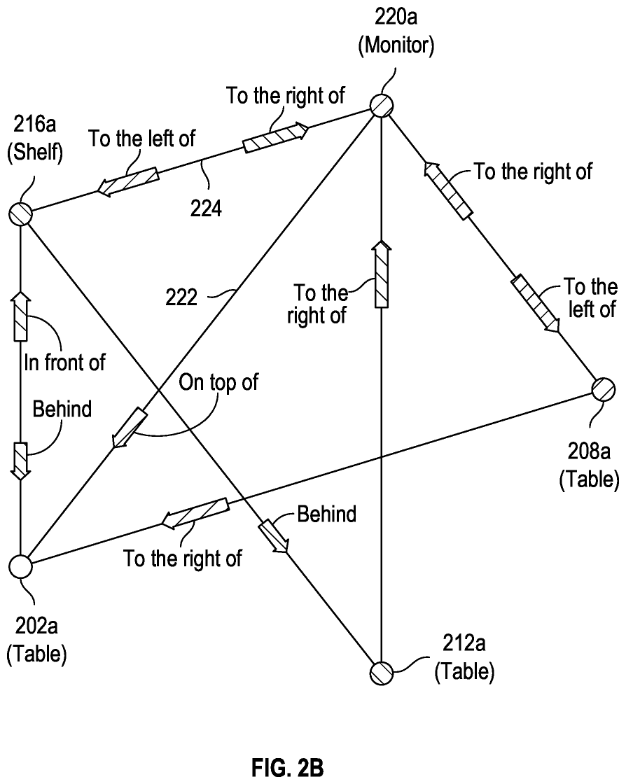

With reference now to FIGS. 2A-5, exemplary techniques for virtual object placement based on referential expressions are described.

FIG. 2A depicts image information 200 corresponding to the surrounding environment of an electronic device, such as device 100a for example. The environment may include various physical objects, such as tables, shelves, chairs, walls, windows, electronics, and the like. In this example, the device environment includes several tables, a shelf, and a monitor. Upon receiving image information 200, the device identifies one or more objects from image information 200. In general, object detection may involve utilization of a lightweight object detection architecture for use on mobile devices, for example, such as a neural network. For instance, a Single Shot Detector (SSD) with a MobileNet backbone may be used. Object detection using SSD may include extracting feature maps corresponding to a respective image, and applying one or more convolution filters to detect objects in the image. By integrating the system with MobileNet, image recognition models can be run in embedded systems and thus are optimized for use on mobile devices. Generally, objects are optionally identified by using class labels, such as, for example, “table,” “chair,” “shelf,” “monitor,” etc. The object identification may involve identification of an object border surrounding the respective identified object. In general, the object border may take the form of the object itself, or may have a predefined shape, such as a rectangle. In particular, the object border may include a top border, a bottom border, a left border, and a right border, for example. The border may be identified relative to the perspective of image sensors of the device. In particular, as the image information changes based on movements of the image sensors, the identified borders of the identified objects may also change. For instance, as the device moves closer to a chair in the device environment, the border corresponding to the chair may become larger. Similarly, as an object within the environment is physically moved away from the device, the border may become smaller.

Object identification may involve detecting border 202 corresponding to the border of table object 204. Similarly, borders 206 and 210 may correspond to the borders of table objects 208 and 212, respectively. Border 214 may correspond to shelf object 216, and border 218 may correspond to monitor object 220. Based on the identified objects and/or the corresponding object borders, relative positional relationships between the objects are further identified. In general, a relationship estimation network may determine the relative positional relationships. Specifically, the relationship estimation network may be based on a Permutation Invariant Structured Prediction (PISP) model, utilizing visual features from an object detector and relying on class label distributions passed from a detector stage as input to a scene graph generation stage. As a result, by continuously performing the estimation on-device, performance is increased by reducing the amount of required training data.

For example, table object 204 may be identified as positioned “in front of” shelf object 216 based on the perspective of the image sensor(s) on the electronic device. Such identification may be based at least in part on a determination that table object 204 is positioned closer to the device than shelf object 216 (e.g., using one or more proximity sensors and/or image sensors). The identification may also be based at least in part on a determination that border 202 is overlapping and/or generally underneath border 214 based on the image sensor perspective. As a result, the positional relationship of table object 204 with respect to shelf object 216 is defined as “in front of,” such that table object 204 has a positional relationship of “in front of” shelf 216. Similarly, monitor object 220 may be identified as positioned “on top of” table object 204. This identification may be based at least in part on a determination that at least a portion of table object 204 (e.g., a front edge) is positioned closer to the device than any portion of monitor object 220. The identification may also be based at least in part on a determination that border 218 is overlapping and/or generally above border 202. As a result, the positional relationship of monitor 220 with respect to table 204 is defined as “on top of,” such that as monitor object 220 has a positional relationship of “on top of” table object 204. In general, as the image information changes based on movements of the image sensors, the positional relationships corresponding to the objects may change. For instance, if the physical monitor corresponding to monitor object 220 is moved from the physical table corresponding to table object 202 to the physical table corresponding to table object 212, the positional relationships corresponding to these objects may change. After such movement, the positional relationship of monitor object 220 may be defined as “on top of” table object 212. Similarly, the positional relationship of monitor object 220 may be defined as “behind” table object 202, after the movement.

Referring now to FIG. 2B, an exemplary scene graph is depicted. In general, the scene graph includes information regarding objects detected based on image information, and relationships between the objects. Here, the scene graph may be generated by an object relationship estimation model using the image information 200 as input. In particular, object nodes may correspond to objects detected in an environment, such as table nodes 202a, 208a, and 212a, shelf node 216a, and monitor node 220a. Various nodes may be interconnected to other nodes by positional relationship connections. For example, table node 202a is connected to monitor node 220a via connection 222. Specifically, connection 222 may indicate that the monitor associated with monitor node 220a has a positional relationship of “on top of” the table corresponding to table node 202a. Similarly, shelf 216a is connected to monitor node 220a via connection 224. Connection 224 may indicate that the monitor associated with monitor node 220a has a positional relationship of “to the left of” the shelf corresponding to shelf node 216a. Additionally, connection 224 may indicate that the shelf corresponding to shelf node 216a has a positional relationship of “to the right of” the monitor associated with monitor node 220a. Connections may include various positional relationships between various objects based on the relative positions of the objects within the environment. For example, a first object may be described as having a positional relationship of “to the right of” a second object, as well as “in front of” or “next to” the second object.

Based on the generated scene graph, a plurality of reference sets are determined. Each reference set may include a first object and a second object, and a corresponding positional relationship between the objects. The reference sets may also be referred to as “triplets” in some contexts. For example, a reference set such as “monitor, on top of, table” may correspond to the relationship between monitor node 220a and table node 202a. Another reference set may include “shelf, to the left of, monitor,” which may correspond to the relationship between shelf node 216a and monitor node 220a. In some examples, the plurality of reference sets may include all of the positional relationships between objects in a given device environment.

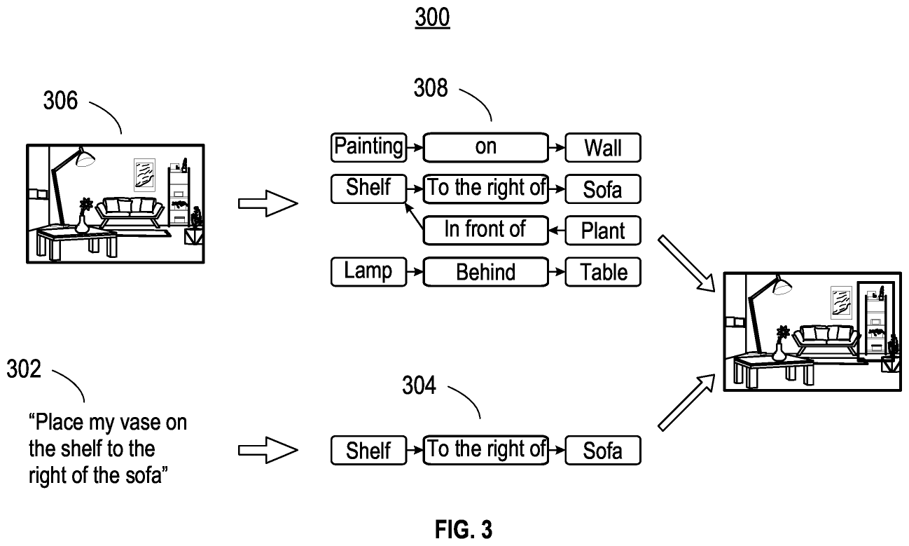

Referring now to FIG. 3, a process 300 for identifying a target object based on a referential expression is depicted. In general, a speech input 302 is received and processed to produce a first reference set 304. A device environment 306 is also processed to produce an image-based scene graph including a plurality of second reference sets 308, as discussed with respect to FIGS. 2A-2B. The plurality of second reference sets 308 may include reference sets such as “painting, on, wall,” “shelf, to the right of, sofa,” and the like. Speech input 302 may include a request, such as “Place my vase on the shelf to the right of the sofa.” In this example, “my vase” may be a reference to a virtual object, such as a virtual object depicted in the scene or a virtual object that has yet to be displayed in a particular environment (e.g., an object the user owns in “virtual inventory”). The referenced virtual object may correspond to a variety of different object types, such as a real-world type object (e.g., a book, a pillow, a plant), a fictional type object (e.g., a dinosaur, a unicorn, etc.), a device application (e.g., a spreadsheet, a weather application, etc.), and the like. The request may further include an action, such as “place” in speech input 302. Other actions may be utilized, such as “move,” “set,” or “hang.” Actions may be referenced implicitly, such as such as “how would [object] look.” Speech input 302 may further include a relational object. In the example speech above, the word “on” may correspond to the relational object. Other relational objects may be used, such as “inside of,” “over,” “next to,” and the like. The relational object may generally describe how to place the virtual object with respect to a landmark object. The landmark object in speech input 302 above may correspond to “the shelf to the right of the sofa.” The landmark object may generally include a first object, a relational object, and a second object, as described herein.

Upon receiving speech input 302, a first reference set 304 may be obtained from speech input 302. In particular, a sequence tagging model may be trained, which takes a natural language query as input and assigns respective tokens with a corresponding tags including the referenced virtual objects, relational objects, and landmark objects. A pre-trained encoder, such as a BERT encoder (Bi-directional Encoder Representation from Transformers) or modified BERT encoder may be utilized. A linear classification layer may, for example, be utilized on top of a final layer of the BERT encoder in order to predict token tags. In general, the speech input is passed to an input layer of the encoder such that positional embedding are obtained based on identified words in the speech input. The input may then be passed through the encoder to obtain BERT token embeddings, such that the output is received via the linear classification layer to obtain respective token tags. The first reference set 304 may then be obtained by identifying the landmark object, which further includes a first object, a second object, and a positional relationship between the first and second object.

Different structural components of the reference sets may be identified using various techniques. For example, node labels and parent indices associated with the identified tokens may be considered in order to further enhance object identification. In particular, a parent index may define the token to which a respective token modifies, refers to, or is otherwise related to. As an example, the token associated with the word “brown” in the landmark phrase “the brown shelf to the right of the sofa” may have a parent index corresponding to the token associated with the word “shelf.” A node label may further define the type of token. For example, the token associated with the word “brown” in the landmark phrase “the brown shelf to the right of the sofa” may have a node label of “attribute,” whereas the token associated with the word “shelf” in this phrase may have a node label of “object.” The node labels and parent indices may be predicted by the underlying neural network at least in part based on leveraging attention among tokens from various layers and heads. For instance, tokens and/or corresponding labels and indices are identified by selecting specific layers and layer heads for attention. This selection may involve averaging attention scores across layers and/or “maxpooling” attention scores across layer heads, in order to predict parent indices, for example.

Upon obtaining first reference set 304, the first reference set 304 may be compared to the plurality of second reference sets 308. Each reference set of the plurality of second reference sets 308 may include a respective first object, a respective second object, and a respective relationship object. For example, with respect to an exemplary reference set “lamp, behind, table,” the respective first object may correspond to “lamp,” the respective second object may correspond to “table,” and the respective first relationship object may correspond to “behind.” In particular instances, a reference set may include a plurality of objects and a plurality of relationship objects. For example, a reference set of the plurality of second reference sets 308 may include “plant (object), in front of (relationship object), shelf (object), to the right of (relationship object), sofa (object).” This reference set may define the positional relationship between a plant, a shelf, and sofa in the device environment. Here, the plant may be positioned in front of the shelf, wherein the shelf is positioned to the right of the sofa.

In general, the reference set comparison may involve determining a best match between first reference set 304 and a second reference set from the plurality of second reference sets 308. The comparison may involve determining semantic similarities between objects of first reference set 304 and each reference set of the plurality of second reference sets 308. The comparison may also generally involve determining a distance in a vector space between a representations associated with the reference sets. As an example, the system may determine a distance between an object representation corresponding to first reference set 304 (e.g., a vector representation of “shelf”) and a representation of a second object of a second reference set from plurality of reference sets 308 (e.g., a vector representation of “painting”). The representations may be obtained using systems such as Glove, Word2Vec, and the like. For example, a cosine distance between two respective vector representations may be determined to assess the similarity between two objects. In some examples, a combined semantic representation (e.g., a vector representation) may be obtained corresponding to the entire first reference set 304, and a combined semantic representation may be obtained corresponding to an entire second reference set of the plurality of second reference sets 308. Such combined semantic representations may be obtained using systems such as BERT, Elmo, and the like. The combined semantic representations may then be compared, for example, by determining the distance between the combined semantic representations in a vector space.

As an example, a first semantic similarity may be determined between a first object “shelf” of first reference set 304 and a respective first object “painting” of a given second reference set. Here, a determination is made that objects “shelf” and “painting” have a low semantic similarity (e.g., based on a relatively far distance between corresponding object representations in a vector space). For instance, the words “shelf” and “painting” may correspond to words that are used to describe fundamentally different objects. As another example, a first semantic similarity may be determined between a first object “shelf” of first reference set 304 and a respective first object “rack” of a given second reference set. Here, a determination is made that objects “shelf” and “rack” have a high semantic similarity (e.g., based on a relatively close distance between the object representations in a vector space). In other words, the objects “rack” and “shelf” may correspond to different words that are used to describe the same (or similar) object in an environment. As yet another example, a first semantic similarity may be determined between a first object “shelf” of first reference set 304 and a respective first object “shelf” of a given second reference set. Here, a determination is made that the objects are identical in semantic meaning (e.g., based on each object having the same position in a vector space), and thus, the comparison yields a maximum possible similarity between the objects.

Once the respective similarities are determined between each object of first reference set 304 and each object of a respective second reference set, the similarity values may be combined in order to assign an overall similarity between first reference set 304 and the respective second reference set. For example, first reference set 304 including “shelf, to the right of, sofa” may be compared to a respective second reference set “shelf, next to, couch.” Here, the similarity between the respective objects may include values of 100, 80, and 80, respectively. The similarities may be based on a point scale, such as a 100 point scale (e.g., a value of 100 may indicate identical semantic meaning between objects), resulting in a total combined similarity of 260. First reference set 304 including “shelf, to the right of, sofa” may also be compared to a respective second reference set “painting, next to, wall.” Here, the similarity between the respective objects may include values of 0, 50, and 0, respectively, resulting in a total combined similarity of 50. Additionally, first reference set 304 including “shelf, to the right of, sofa” may be compared to a respective second reference set “shelf, to the right of, sofa.” Here, the similarity between the respective objects may include values of 100, 100, and 100, respectively, resulting in a total combined similarity of 300 (i.e., the reference sets are found to be identical in semantic meaning).

In general, a best matching second reference set from the plurality of second reference sets 308 may be obtained based on the comparison. The obtained second reference set may identified based on a matching score between the first reference set and the second reference set, such as a highest matching score. For instance, the plurality of second reference sets 308 may be ranked according to how well each reference set matches first reference set 304. The second reference set having a highest matching score in the ranked list may then be identified. In some examples, the obtained second reference set may be identified using an “arguments of the maxima” function, for example, such as using Equation 1 shown below. In Equation 1, tⱼ may correspond to first reference set 304, sᵢ may correspond to a respective reference set from the plurality of second reference sets 308, and S_{match} may correspond to the obtained second reference set having a highest match.

$${S}_{match} = {arg max}_{{s}_{i}} {\prod }_{i = 1}^{m} {\prod }_{j = 1}^{n} Sim ( {s}_{i} , {t}_{j} ) \qquad ( 1 )$$

In some examples, in accordance with a determination that two or more references sets of the plurality of second reference sets are associated with equally high matching scores, a user request history is obtained to select an appropriate reference set. For example, a second reference set is selected from the ranked list of reference sets based on one or more components of a user request history, such as a request frequency with respect to a particular object. For example, the selected second reference set may include “shelf, to the right of, sofa.” The user may commonly refer to the “shelf,” such that the request history includes many references to “shelf” such as “shelf, next to, couch,” “shelf, by, sofa,” and the like. The second reference set may also be selected from the ranked list of reference sets based a request frequency with respect to a particular relationship reference, alone or in combination with other object references. For example, the selected second reference set may include “shelf, to the right of, sofa.” The user may commonly refer to the “shelf” using the phrase “shelf, next to, couch,” instead of referencing “shelf, to the right of, couch.” In this example, there may be an additional shelf located “to the left of” the sofa. By using the commonly-referred-to relationship reference “shelf, next to, couch,” the system may intelligently infer that the user is referring to the reference set “shelf, to the right of, couch” instead of the reference set “shelf, to the left of, couch.”

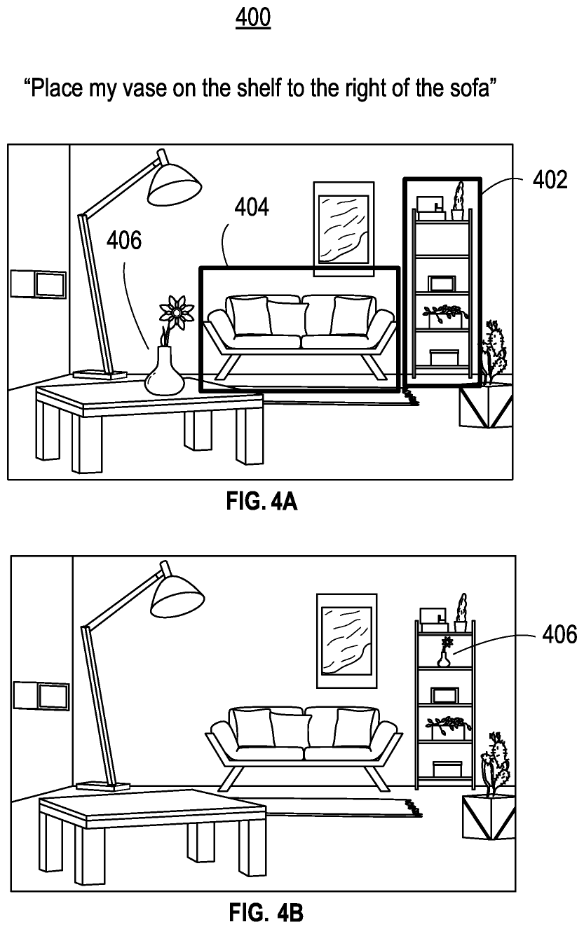

With reference to environment 400 in FIGS. 4A-4B, upon obtaining the second reference set, an object may be identified based on the obtained reference set. In general, the identified object may correspond to the physical object that the user intends to move or otherwise place a referenced virtual object on, proximate to, inside, and the like (e.g., the identified object may correspond to “shelf” in the request “Place my vase on the shelf to the right of the sofa.”). Specifically, identifying an object based on the second reference set may include identifying, from the second reference set, a first respective object (e.g., “shelf”), a second respective object (e.g., “sofa”), and a relationship between the first respective object and the second respective object. Here, the relationship (e.g., “to the right of”) defines a location of the first respective object relative to the second respective object. As discussed herein, the first respective object corresponds to the identified object. The object identification may further involve obtaining a region associated with the first respective object and the second respective object. For example, each object may be associated with a border. The border may include various boundaries, such as a top boundary, a bottom boundary, a left boundary, and a right boundary. In some examples, the obtained region may correspond to the union set of a first boundary corresponding to the first respective object and a second boundary corresponding to the second respective object corresponding to the second respective object.

Based on the identified object, a referenced virtual object is then displayed. For instance, with respect to the request “Place my vase on the shelf to the right of the sofa,” the obtained reference set may correspond to “shelf, to the right of, sofa,” such that the first respective object corresponds to “shelf” and the second respective object corresponds to “sofa.” Here, identified region 402 may correspond to the region of the referenced “shelf” object and identified region 404 may correspond to the region of the referenced “sofa” object. In this example, the referenced virtual object may correspond to “vase,” depicted as object 406 in environment 400. Upon identifying region 402 corresponding to the “shelf” object, referenced virtual object 406 may be depicted as being relocated within environment 400 to new location within identified region 402. The virtual object relocation may involve displaying the object as moving towards identified region 402. In some examples, the virtual object relocation may involve an instantaneous or substantially instantaneous relocation of the object. As depicted in FIG. 4B, referenced virtual object 406 is displayed within identified region 402 once the virtual object relocation has completed.

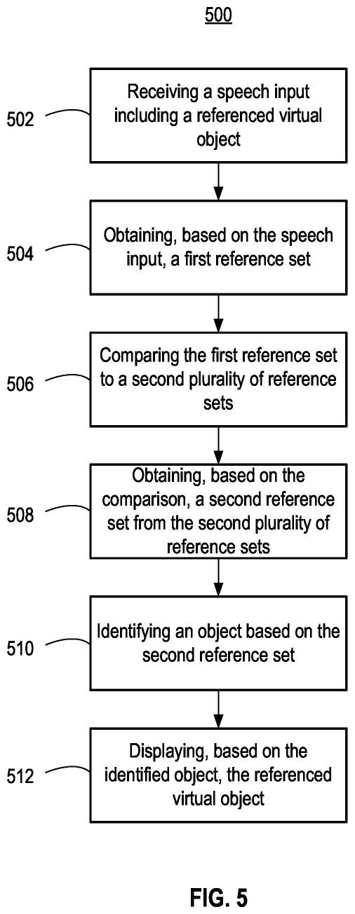

Referring to FIG. 5, a flow chart of an exemplary process 500 for displaying a virtual display in an extended reality setting is depicted. Process 500 can be performed using a user device (e.g., device 100a). For example, the user device may be a handheld mobile device or a head-mounted device. In some embodiments, process 500 is performed using two or more electronic devices, such as a user device that is communicatively coupled to another device. The display of the user device may be transparent or opaque in various examples. Process 500 can be applied, for example, to extended reality applications, such as virtual reality, augmented reality, or mixed reality applications. Process 500 may also involve effects that include visible features as well as non-visible features, such as audio, haptic, or the like. One or more blocks of process 500 can be optional and/or additional blocks may be performed. Furthermore, the blocks of process 500 are depicted in a particular order, it should be appreciated that these blocks can be performed in other orders.

At block 502, a speech input including a referenced virtual object is received. In some examples, image information associated with a device environment is received, a plurality of objects are identified from the image information, a plurality of relationships between objects in the plurality of objects are identified, and the plurality of second reference sets are generated based on the identified objects and identified plurality of relationships. In some examples, a first respective object and a second respective object are identified from the plurality of objects, and a relationship between the first respective object and the second respective object is identified, wherein the relationship defines a location of the first respective object relative to the second respective object.

At block 504, a first reference set is obtained based on the speech input. In some examples, a plurality of words are identified from the speech input, and the plurality of words are provided to an input layer. In some examples, a plurality of tokens based on the plurality of words are obtained from an output layer, and the first reference set is obtained based on the plurality of tokens. In some examples, the plurality of words include the referenced virtual object, a relational object, and a landmark object. In some examples, a plurality of tokens are obtained from an output layer based on the speech input. In some examples, a plurality of tokens are obtained from an output layer based on the speech input, and a parent index and a label classifier are identified for each token of the plurality of tokens. In some examples, the first reference set is obtained based on the plurality of tokens. In some examples, a plurality of layers are obtained based on the speech input, wherein each layer is associated with a head object. In some examples, a parent index is identified for each token of the plurality of tokens, wherein each parent index is determined based on a plurality of scores associated with the head objects.

At block 506, the first reference set is compared to a plurality of second reference sets. In some examples, the first reference set includes a first object, a second object, and a first relationship object, and each reference set of the plurality of second reference sets includes a respective first object, a respective second object, and a respective first relationship object. In some examples, comparing include comparing, for each reference set of the plurality of second reference sets, a first semantic similarity between the first object and the respective first object, a second semantic similarity between the second object and the respective second object, and a third semantic similarity between the first relationship object and the respective first relationship object. In some examples, comparing includes determining a distance between an object of the first reference set and an object of the plurality of second reference sets, and comparing the first reference set to the plurality of second reference sets based on the determined distance. In some examples, comparing includes obtaining, for each reference set of the plurality of second reference sets, a vector representation, and comparing a vector representation of the first reference set to each vector representation obtained from the plurality of second reference sets.

At block 508, a second reference set is obtained, based on the comparison, from the plurality of second reference sets, wherein the second reference set is identified based on a matching score between the first reference set and the second reference set. In some examples, obtaining a second reference set from the plurality of second reference sets includes obtaining a ranked list of reference sets from the plurality of second reference sets, wherein each reference set of the ranked list is associated with a matching score, and selecting a second reference set having a highest matching score from the ranked list of reference sets. In some examples, the second reference set having a highest matching score is determined based on an arguments of the maxima function. In some examples, in accordance with a determination that two or more references sets of the plurality of second reference sets are associated with equal highest matching scores, a second reference set is selected, from the two or more reference sets, from the ranked list of reference sets based on a request history. In some examples, selecting, from the two or more reference sets, a second reference set having a highest matching score from the ranked list of reference sets based on a user input history includes determining, based on the two or more reference sets, at least one of an object reference frequency and a relationship reference frequency, and selecting, from the two or more reference sets, a second reference set having a highest matching score from the ranked list of reference sets based on at least one of the object reference frequency and the relationship reference frequency.

At block 510, an object is identified based on the second reference set. In some examples, identifying an object based on the second reference set includes identifying, from the second reference set, a first respective object, a second respective object, and a relationship between the first respective object and the second respective object, wherein the relationship defines a location of the first respective object relative to the second respective object, and the first respective object corresponds to the objected identified based on the second reference set. In some examples, identifying an object based on the second reference set includes identifying, from the second reference set, a first respective object, a second respective object, and a relationship between the first respective object and the second respective object, and obtaining a region associated with the first respective object and the second respective object. In some examples, a first region associated with the first respective object is identified, wherein the first region includes a first top boundary, a first bottom boundary, a first left boundary, and a first right boundary. In some examples, the referenced virtual object is displayed within the identified first region. In some examples, a second region associated with the second respective object is identified, wherein the second region includes a second top boundary, a second bottom boundary, a second left boundary, and a second right boundary, and a third region is identified associated with the first respective object and the second respective object corresponding to a union of the first region and the second region. At block 512, the referenced virtual object is displayed based on the identified object.

As described above, one aspect of the present technology is the gathering and use of data available from various sources to improve virtual object placement based on referential expressions. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to enhance the accuracy of virtual object placement based on referential expressions. Accordingly, use of such personal information data enables users to calculated control of the virtual object placement. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of virtual object placement using referential expressions, the present technology can be configured to allow users to select to “opt in” or “opt out” of participation in the collection of personal information data during registration for services or anytime thereafter. In another example, users can select not to provide environment-specific information for virtual object placement using referential expressions. In yet another example, users can select to limit the length of time environment-specific data is maintained or entirely prohibit certain environment-specific data from being gathered. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the system for virtual object placement based on referential expressions, or publicly available information.

1. A electronic device, comprising:
one or more processors; and
memory storing one or more programs configured to be executed by the one or more processors, the one or more programs including instructions for:
receiving a speech input including a referenced virtual object;
obtaining, based on the speech input, a first reference set;
comparing the first reference set to a plurality of second reference sets;
obtaining, based on the comparison, a second reference set from the plurality of second reference sets, wherein the second reference set is identified based on a matching score between the first reference set and the second reference set;
identifying an object based on the second reference set; and
displaying, based on the identified object, the referenced virtual object.

2. The electronic device of claim 1, the one or more programs including instructions for:
identifying, from the speech input, a plurality of words;
providing the plurality of words to an input layer;
obtaining, from an output layer, a plurality of tokens based on the plurality of words; and
obtaining, based on the plurality of tokens, the first reference set.

3. The electronic device of claim 2, wherein the plurality of words include the referenced virtual object, a relational object, and a landmark object.

4. The electronic device of claim 1, the one or more programs including instructions for:
obtaining, from an output layer, a plurality of tokens based on the speech input;
identifying, for each token of the plurality of tokens, a parent index and a label classifier; and
obtaining, based on the plurality of tokens, the first reference set.

5. The electronic device of claim 1, comprising:
obtaining, from an output layer, a plurality of tokens based on the speech input;
obtaining a plurality of layers based on the speech input, wherein each layer is associated with a head object; and
identifying, for each token of the plurality of tokens, a parent index, wherein each parent index is determined based on a plurality of scores associated with the head objects.

6. The electronic device of claim 1, wherein the first reference set includes a first object, a second object, and a first relationship object, and each reference set of the plurality of second reference sets includes a respective first object, a respective second object, and a respective first relationship object, wherein comparing comprises:
comparing, for each reference set of the plurality of second reference sets:
a first semantic similarity between the first object and the respective first object;
a second semantic similarity between the second object and the respective second object;
a third semantic similarity between the first relationship object and the respective first relationship object.

7. The electronic device of claim 1, wherein comparing comprises:
determining a distance between an object of the first reference set and an object of the plurality of second reference sets; and
comparing the first reference set to the plurality of second reference sets based on the determined distance.

8. The electronic device of claim 1, wherein comparing comprises:
obtaining, for each reference set of the plurality of second reference sets, a vector representation; and
comparing a vector representation of the first reference set to each vector representation obtained from the plurality of second reference sets.

9. The electronic device of claim 1, wherein obtaining a second reference set from the plurality of second reference sets comprises:
obtaining a ranked list of reference sets from the plurality of second reference sets, wherein each reference set of the ranked list is associated with a matching score; and
selecting a second reference set having a highest matching score from the ranked list of reference sets.

10. The electronic device of claim 9, wherein the second reference set having a highest matching score is determined based on an arguments of the maxima function.

11. The electronic device of claim 9, the one or more programs including instructions for:
in accordance with a determination that two or more references sets of the plurality of second reference sets are associated with equal highest matching scores:
selecting, from the two or more reference sets, a second reference set from the ranked list of reference sets based on a request history.

12. The electronic device of claim 11, wherein selecting, from the two or more reference sets, a second reference set having a highest matching score from the ranked list of reference sets based on a user input history comprises:
determining, based on the two or more reference sets, at least one of an object reference frequency and a relationship reference frequency; and
selecting, from the two or more reference sets, a second reference set from the ranked list of reference sets based on at least one of the object reference frequency and the relationship reference frequency.

13. The electronic device of claim 1, wherein identifying an object based on the second reference set comprises:
identifying, from the second reference set, a first respective object, a second respective object, and a relationship between the first respective object and the second respective object, wherein
the relationship defines a location of the first respective object relative to the second respective object, and
the first respective object corresponds to the objected identified based on the second reference set.

14. The electronic device of claim 1, wherein identifying an object based on the second reference set comprises:
identifying, from the second reference set, a first respective object, a second respective object, and a relationship between the first respective object and the second respective object; and
obtaining a region associated with the first respective object and the second respective object.

15. The electronic device of claim 14, the one or more programs including instructions for:
identifying a first region associated with the first respective object, wherein the first region includes a first top boundary, a first bottom boundary, a first left boundary, and a first right boundary; and
displaying the referenced virtual object within the identified first region.

16. The electronic device of claim 15, the one or more programs including instructions for:
identifying a second region associated with the second respective object, wherein the second region includes a second top boundary, a second bottom boundary, a second left boundary, and a second right boundary; and
identifying a third region associated with the first respective object and the second respective object corresponding to a union of the first region and the second region.

17. The electronic device of claim 1, the one or more programs including instructions for:
receiving image information associated with a device environment;
identifying a plurality of objects from the image information;
identifying a plurality of relationships between objects in the plurality of objects; and
generating the plurality of second reference sets based on the identified objects and identified plurality of relationships.

18. The electronic device of claim 17, the one or more programs including instructions for:
identifying a first respective object and a second respective object from the plurality of objects; and
identifying a relationship between the first respective object and the second respective object, wherein the relationship defines a location of the first respective object relative to the second respective object.

19. (canceled)

20. (canceled)

21. (canceled)

22. A non-transitory computer-readable storage medium storing one or more programs configured to be executed by one or more processors of an electronic device, the one or more programs including instructions for:
receiving a speech input including a referenced virtual object;
obtaining, based on the speech input, a first reference set;
comparing the first reference set to a plurality of second reference sets;
obtaining, based on the comparison, a second reference set from the plurality of second reference sets, wherein the second reference set is identified based on a matching score between the first reference set and the second reference set;
identifying an object based on the second reference set; and
displaying, based on the identified object, the referenced virtual object.

23. A method, comprising:
receiving a speech input including a referenced virtual object;
obtaining, based on the speech input, a first reference set;
comparing the first reference set to a plurality of second reference sets;
obtaining, based on the comparison, a second reference set from the plurality of second reference sets, wherein the second reference set is identified based on a matching score between the first reference set and the second reference set;
identifying an object based on the second reference set; and
displaying, based on the identified object, the referenced virtual object.

24. (canceled)
